(19) United States
(12) Patent Application Publication
(10) Pub. No.: US 2007/0063952 A1
(43) Pub. Date: Mar. 22, 2007

(54) Driving methods and devices using the same

(75) Inventors: Norio Oku, Taipei City (TW); Keiichi Sano, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Toppoly Optoelectronics Corp.

(21) Appl. No.: 11/229,881

(22) Filed: Sep. 19, 2005

(51) Int. Cl. G09G 3/36

(52) U.S. Cl. 345/96

(57) ABSTRACT

Driving methods and devices are provided. In a representative method, N^{th} and (N+K)^{th} rows of pixels are scanned sequentially and a signal of a first polarity is provided in sequence to the N^{th} and (N+K)^{th} rows of scanned pixels, during a first period of a frame period. During a second period of the frame period, (N+l)^{th} and (N+K+1)^{th} rows of pixels are scanned sequentially and a signal of a second polarity is provided in sequence to the (N+1)^{th} and (N+K+1)^{th} rows of scanned pixels, wherein N and K are both integers, N>0, K is even and K>1.

### BACKGROUND

The invention relates to driving methods for display devices, such as liquid display devices (LCDs).

High definition, multicolor display, low power consumption, lower voltage requirements and light weight have made liquid crystal displays (LCDs) a leading display device technology. LCDs have been used for several years as mobile information displays in, for example, personal digital assistants (PDAs), portable computers, mobile phones, and the like.

In LCDs, liquid crystal material can degrade if an electric field is applied thereto continuously in the same direction. Thus, the direction in which the electric field is applied should be constantly changed. Namely, pixel electrode voltage (data signal) typically alternates between positive values and negative values. Such switching of electrode voltage values is referred to as inversion driving. Typically, inversion driving methods include dot inversion, , column inversion, line inversion, and dot column inversion.

FIG. 1 is a schematic diagram of a part of a typical LCD panel circuit. As shown, the circuit includes data lines Dn−1, Dn and Dn+1, scan lines Gm−1, Gm and Gm+1, and corresponding display units PL. FIG. 2A is a schematic diagram of video signal polarization received by display units in the form of line inversion. As shown, the left side is an odd frame having data signal polarization received by display units in a panel defined by data electrodes Dn−1, Dn and Dn+1 and scan electrodes Gm−1, Gm and Gm+1, and the right side is an even frame having data signal polarization received by display units in a panel defined by the data electrodes Dn−1, Dn, Dn+1, and the scan electrodes Gm−1, Gm and Gm+1. Display units in the same row, such as Gm, receive the same polarization data signals while display units on two adjacent rows, such as Gm−1 and Gm+1, receive opposite polarization data signals.

FIG. 3A is a timing chart of the circuit shown in FIG. 2A using line inversion driving. During time interval PD1, the scan line Gm−1 is activated, positive polarization data signals DS on data lines Dn−1, Dn and Dn+1, are coupled to a corresponding display unit respectively. In this time, the polarization of the common voltage is negative. During time interval PD2, the scan line Gm is activated, negative polarization data signals DS on data lines Dn−1, Dn and Dn+1, are coupled to a corresponding display unit respectively. In time interval PD2, the polarization of the common voltage is positive. During time interval PD3, the scan line Gm+1, is activated, positive polarization data signals DS on lines Dn−1, Dn and Dn+1, are coupled to a corresponding display unit respectively. In this time interval, the polarization of the common voltage is negative. Namely, as each scan line is activated, the polarization of the data signals DS and the common voltage Vcom switches once. However, because the polarization switching frequency of the data signals DS equals the scan frequency of the scan lines, power consumption is high.

FIG. 2B is a schematic diagram of video signal polarization received by display units in the form of N-lines inversion. FIG. 3B is a timing chart of the circuit shown in FIG. 2B using an N-lines inversion driving method. During time interval PD1, the scan line Gm−1 is activated, and positive polarization data signals DS on lines Dn−1, Dn and Dn+1, are coupled to a corresponding display unit respectively. During time interval PD2, the scan line Gm is activated, and positive polarization data signals DS on lines Dn−1, Dn and Dn+1, are coupled to a corresponding display unit respectively. In the time intervals PD1 and PD2, the polarization of the common voltage VCOM is negative. During time interval PD3, the scan line Gm+1, is activated, and negative polarization data signals DS on lines Dn−1, Dn and Dn+1, are coupled to a corresponding display unit respectively. In this time, the polarization of the common voltage is positive. Namely, as each two scan lines are activated in turn, the polarization of the data signals DS and common voltage VCOM switches once. This method, however, can generate flicker due to fewer polarization switches of the data signals DS and common voltage.

### SUMMARY

Driving methods and devices are provided. An embodiment of such a driving method involves a display panel comprising pixels formed in rows. In this method, N^{th} and (N+K)^{th} rows of pixels are scanned sequentially and a signal of a first polarity is provided in sequence to the N^{th} and (N+K)^{th} rows of scanned pixels, during a first period of a frame period. During a second period of the frame period, (N+1)^{th} and (N+K+1)^{th} rows of pixels are scanned sequentially and a signal of a second polarity is provided in sequence to the (N+1)^{th} and (N+K+1)^{th} rows of scanned pixels, wherein N and K are both integers, N>0, K is even and K>1.

An embodiment of a device comprises a display element, a gate driver and a data driver. The display element comprises pixels formed in rows. The gate driver comprises a plurality of parallel gate lines, each line coupled to a corresponding row of pixels. The gate driver scans a first row and a second row of pixels in sequence during a first period of a frame period, and scans a third row and fourth row of pixels during a second period of the frame period. The first and second rows of pixels are not adjacent nor the third and fourth rows of pixels. The data driver comprises a plurality of parallel data lines, each data line orthogonal to the gate lines, and coupled to a corresponding column of pixels. The data driver provides a signal of a first polarity in sequence to the scanned rows of pixels during the first period and a signal of a second polarity in sequence to the scanned rows of pixels during the second period.

### DESCRIPTION OF THE DRAWINGS

The invention can be more fully understood by the subsequent detailed description and examples with reference made to the accompanying drawings, wherein:

FIG. 1 is a schematic diagram of a part of a typical LCD panel circuit;

FIG. 2A is a schematic diagram of video signal polarization received by display units utilizing line inversion of the prior art;

FIG. 2B is a schematic diagram of video signal polarization received by display units utilizing N-lines inversion of the prior art;

FIG. 3A is a timing chart of the circuit shown in FIG. 2A utilizing line inversion of the prior art;

FIG. 3B is a timing chart of the circuit shown in FIG. 2B utilizing N-lines inversion of the prior art;

FIG. 4 shows an embodiment of a display device;

FIG. 5A is a timing chart depicting a first embodiment of a method of operating a display device;

FIG. 5B is a timing chart depicting a second embodiment of a method of operating a display device;

FIG. 5C is a timing chart depicting a third embodiment of a method of operating a display device;

FIG. 5D is a timing chart depicting a fourth embodiment of a method of operating a display device; and

FIG. 6 schematically shows an embodiment of an electronic device incorporating an embodiment of a display device.

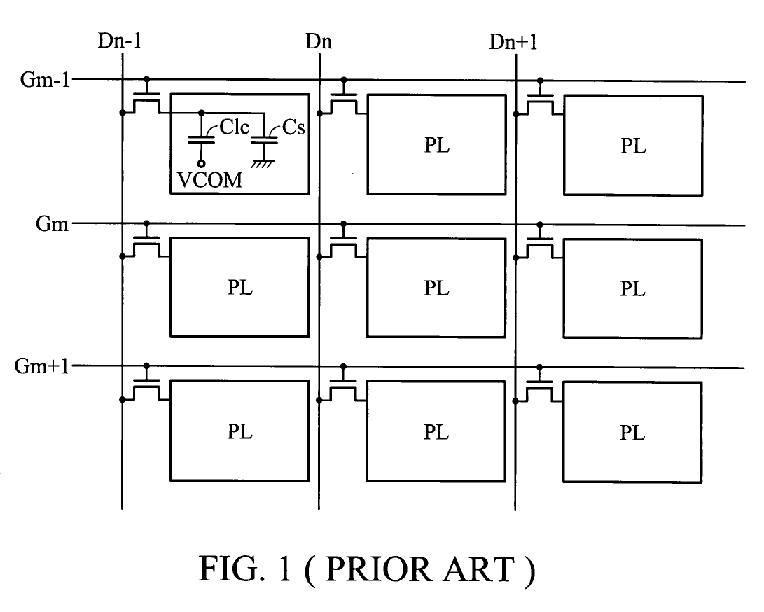

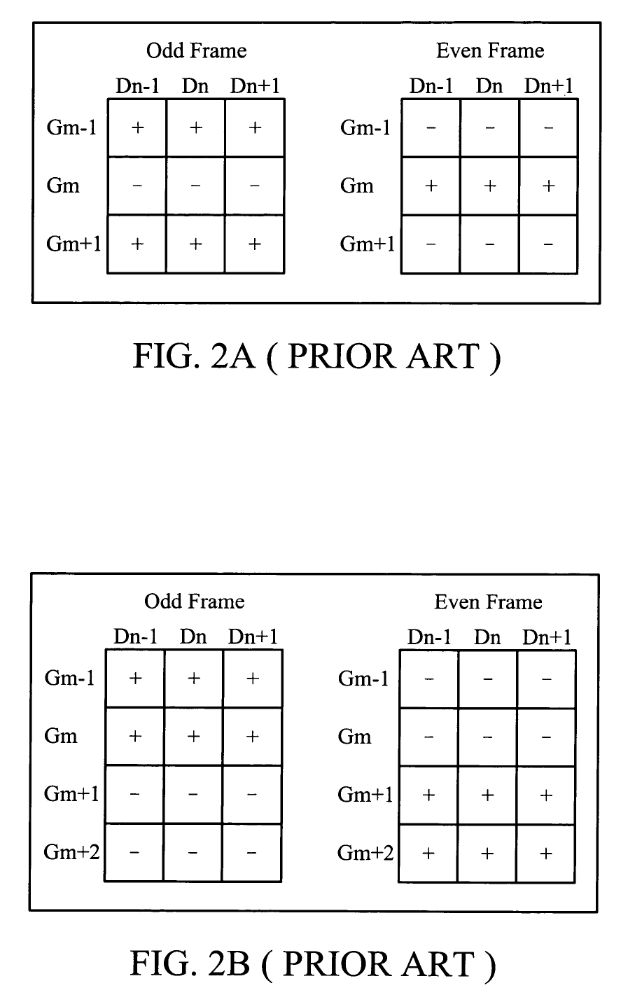

### DETAILED DESCRIPTION

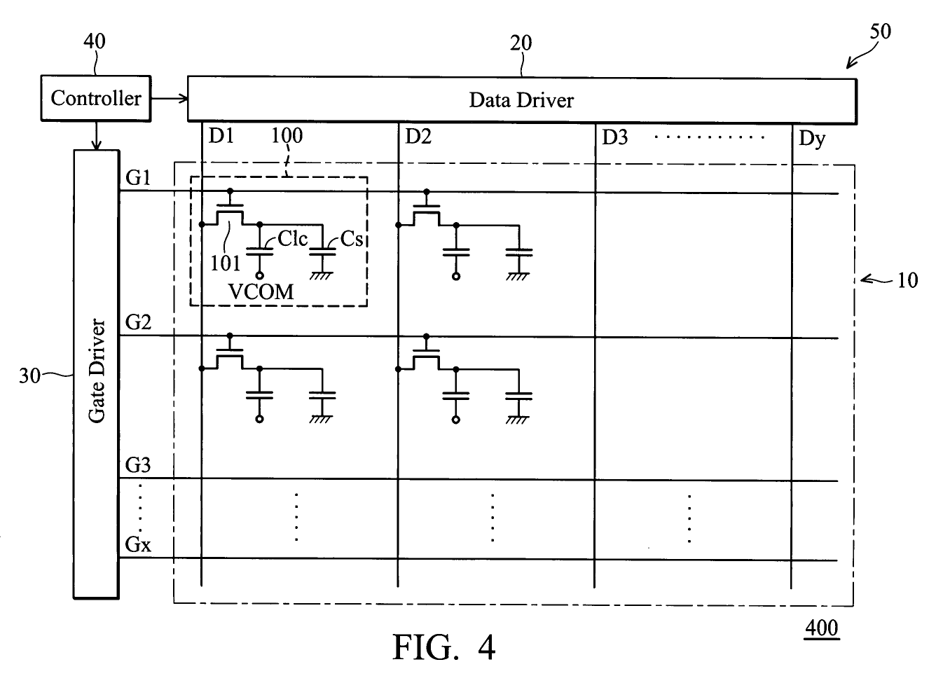

FIG. 4 shows an embodiment of a display device. As shown, the display device 400 comprises a display element 10 and a driving circuit 50. In the display device 400, the display element 10 that is operatively coupled to the driving circuit 50 is an LCD element. The display element 10 comprises a plurality of pixels 100 arranged in a matrix. In other embodiments, the display element 10 could be a plasma display element, an organic light emitting display element, or a cathode ray tube display element, for example.

As shown in FIG. 4, the driving circuit 50 drives the matrix of pixels 100 of an LCD device formed in X rows and Y columns, wherein X and Y are integers. Driving circuit 50 comprises a data driver 20, a gate driver 30 and a controller 40. Data driver 20 includes a plurality of parallel data lines D1˜Dy. Each data line D1˜Dy is coupled to a corresponding column of pixels 100. For example, pixels 100 can each comprise a switching transistor 101 having a first terminal coupled to a corresponding data line, a control terminal coupled to a corresponding scan line, and a second terminal coupled to first terminals of a liquid crystal element Clc and a storage capacitor Cs. The second terminals of the liquid crystal elements Clc are coupled to a common voltage VCOM and the second terminals of the storage capacitors are coupled to a ground voltage.

Gate driver 30 includes a plurality of parallel gate lines G1˜Gx, each orthogonal to data lines D1˜Dy. Each gate line G1˜Gx is coupled to a corresponding row of pixels 100. Controller 40 controls scanning of the gate driver 30 and signal providing of the data driver 20, and, for example, can be a timing controller.

In this embodiment, the gate driver 30 scans a first row and a second row of pixels in sequence and the data driver 20 provides a signal of a first polarity in sequence to the scanned (first and second) rows of pixels during a first period of a frame period. The gate driver 30 scans a third row and fourth row of pixels and the data driver 20 provides a signal of a second polarity in sequence to the scanned (third and fourth) rows of pixels during a second period of the frame period. In this embodiment, a frame period comprises at least one first period and at least one second period, the first and second rows of pixels are not adjacent to each other and the third and fourth rows of pixels are not adjacent to each other.

In some embodiments, the gate driver 30 scans N^{th} and (N+K)^{th} rows of pixels sequentially and the data driver 20 provides a signal of a first polarity in sequence to the N^{th} and (N+K)^{th} rows of scanned pixels, during a first period of a frame period. During a second period of the frame period, the gate driver 30 scans (N+1)^{th} and (N+K+1)^{th} rows of pixels are scanned sequentially and the data driver 20 provides a signal of a second polarity in sequence to the (N+1)^{th} and (N+K+1)^{th} rows of scanned pixels, wherein N and K are both integers, N>0, K is even and K>1.

First Embodiment of a Driving Method

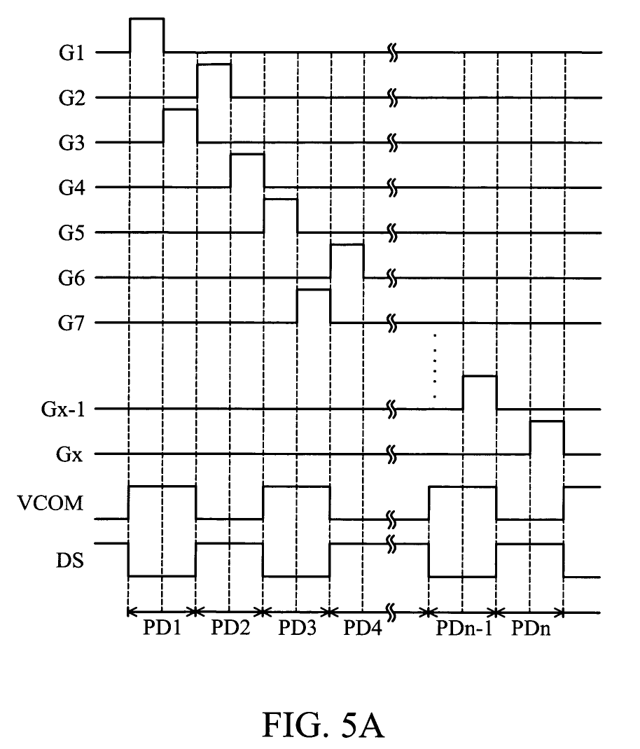

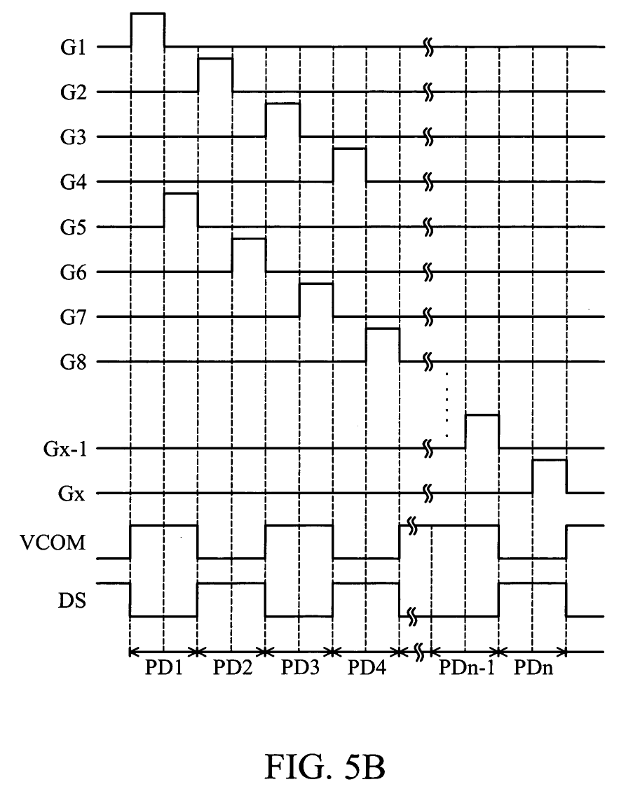

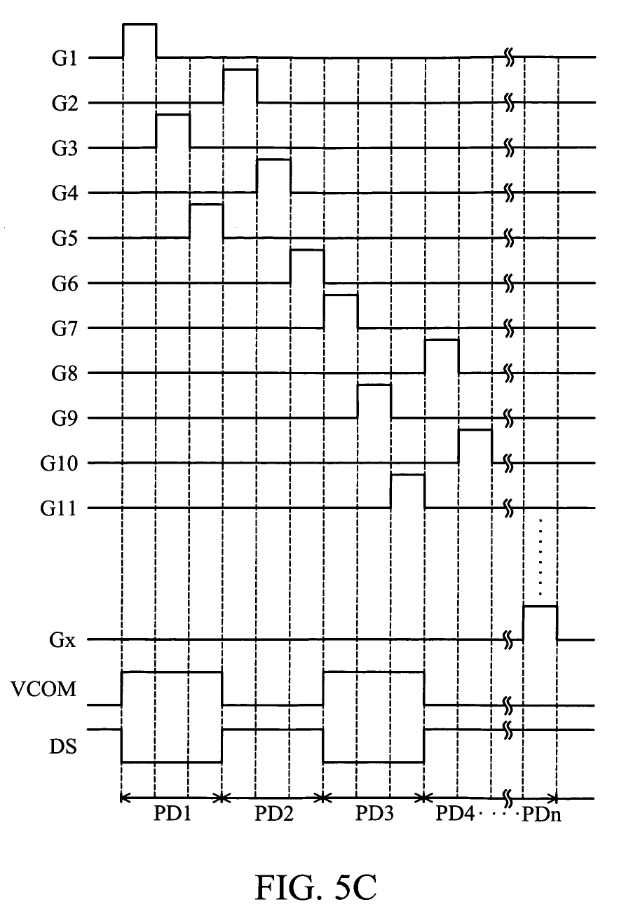

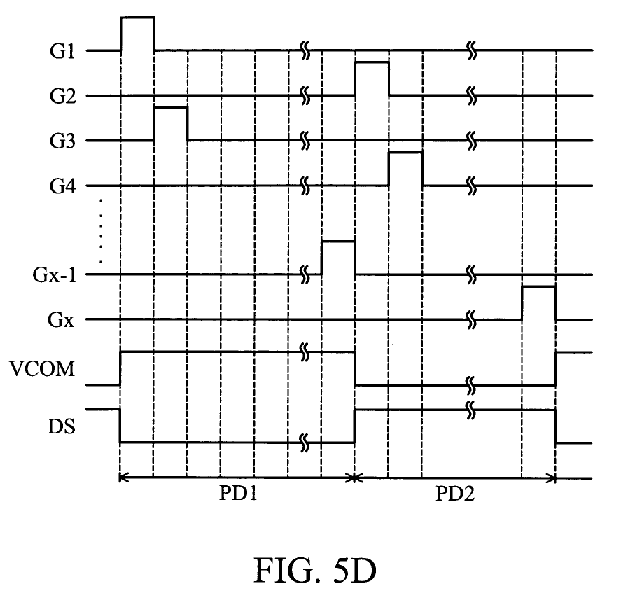

FIG. 5A is a timing chart depicting a first embodiment of a method of operating a display device. As shown, one frame period comprises periods PD1, PD2, PD3, PD4, . . . , PDn−1 and PDn. In this embodiment, N is from 1 to n and K is 2, while it is to be understood that the invention is not limited thereto.

During period PD1, the gate driver 30 scans the gate lines G1 and G3 in sequence and the data driver 20 provides data signals DS of a first polarity in sequence to the scanned rows of pixels. For example, if the common voltage VCOM is kept at a positive voltage level, the first polarity is a negative voltage level with respect to the common voltage VCOM during the period PD1.

During period PD2, the gate driver 30 scans the gate lines G2 and G4 in sequence and the data driver 20 provides data signals DS of a second polarity in sequence to the scanned rows of pixels. For example, if the common voltage VCOM is kept at a negative voltage level, the second polarity is a positive voltage level with respect to the common voltage VCOM during the period PD2.

During period PD3, the gate driver 30 scans the gate lines G5 and G7 in sequence and the data driver 20 provides data signals DS of the first polarity in sequence to the scanned rows of pixels, and so on. During period PDn, the gate driver 30 scans the gate lines Gx−2 and Gx in sequence and the data driver 20 provides data signals DS of the second polarity in sequence to the scanned rows of pixels.

Second Embodiment of a Driving Method

FIG. 5B is a timing chart depicting a second embodiment of a method of operating a display device. As shown, the frame period comprises periods PD1, PD2, PD3, PD4, . . . , PDn−1 and PDn. In this embodiment, N is from 1 to n and K is 4, while it is to be understood that the invention is not limited thereto.

During period PD1, the gate driver 30 scans the gate lines G1 and G5 in sequence and the data driver 20 provides data signals DS of a first polarity in sequence to the scanned rows of pixels.

During period PD2, the gate driver 30 scans the gate lines G2 and G6 in sequence and the data driver 20 provides data signals DS of a second polarity in sequence to the scanned rows of pixels.

During period PD3, the gate driver 30 scans the gate lines G3 and G7 in sequence and the data driver 20 provides data signals DS of the first polarity in sequence to the scanned rows of pixels.

During period PD4, the gate driver 30 scans the gate lines G4 and G8 in sequence and the data driver 20 provides data signals DS of the second polarity in sequence to the scanned rows of pixels, and so on. During period PDn, the gate driver 30 scans the gate lines Gx−4 and Gx in sequence and the data driver 20 provides data signals DS of the second polarity in sequence to the scanned rows of pixels.

In another example, the gate driver 30 scans N^{th} , (N+K)^{th}, and (N+2K)^{th} rows of pixels sequentially and the data driver 20 provides a signal of a first polarity in sequence to the scanned rows of pixels, during a first period of a frame period. During a second period of the frame period, the gate driver 30 scans (N+1)^{th}, (N+K+1)^{th}, and (N+2K+1)^{th} rows of pixels sequentially and the data driver 20 provides a signal of a second polarity in sequence to the scanned rows of pixels, wherein N and K are both integers, N>0, K is even and K>1.

Third Embodiment of a Driving Method

FIG. 5C is a timing chart depicting a third embodiment of a method of operating a display device. As shown, one frame period comprises periods PD1, PD2, PD3, PD4, . . . , and PDn. In this embodiment, N is from 1 to n and K is 2, while it is to be understood that the invention is not limited thereto.

During period PD1, the gate driver 30 scans the gate lines G1, G3 and G5 in sequence and the data driver 20 provides data signals DS of a first polarity in sequence to the scanned rows of pixels. During period PD2, the gate driver 30 scans the gate lines G2, G4 and G6 in sequence and the data driver 20 provides data signals DS of a second polarity in sequence to the scanned rows of pixels.

During period PD3, the gate driver 30 scans the gate lines G7, G9 and G11 in sequence and the data driver 20 provides data signals DS of the first polarity in sequence to the scanned rows of pixels. During period PD4, the gate driver 30 scans the gate lines G8, G10 and G12 in sequence and the data driver 20 provides data signals DS of the second polarity in sequence to the scanned rows of pixels, and so on. During period PDn, the gate driver 30 scans the gate lines Gx−4, Gx−2 and Gx in sequence and the data driver 20 provides data signals DS of the second polarity in sequence to the scanned rows of pixels.

Alternately, N can be from 1 to n and K is 4. During period PD1, the gate driver 30 scans the gate lines G1, G5 and G9 in sequence and the data driver 20 provides data signals DS of a first polarity in sequence to the scanned rows of pixels. During period PD2, the gate driver 30 scans the gate lines G2, G6 and G10 in sequence and the data driver 20 provides data signals DS of a second polarity in sequence to the scanned rows of pixels. During period PD3 the gate driver 30 scans the gate lines G3, G7 and G11 in sequence and the data driver 20 provides data signals DS of the first polarity in sequence to the scanned rows of pixels. During period PD4 the gate driver 30 scans the gate lines G4, G8 and G12 in sequence and the data driver 20 provides data signals DS of the second polarity in sequence to the scanned rows of pixels and so on.

Fourth Embodiment of a Driving Method

FIG. 5D is a timing chart depicting a fourth embodiment of a method of operating a display device. As shown, one frame period comprises periods PD1 and PD2.

During period PD1, the gate driver 30 scans the odd-numbered gate lines G1, G3, . . . , Gx−1 in sequence and the data driver 20 provides data signals DS of a first polarity in sequence to the scanned rows of pixels. For example, if the common voltage VCOM is kept at a positive voltage level, the first polarity is a negative voltage level with respect to the common voltage VCOM during the period PD1.

During period PD2, the gate driver 30 scans the even-numbered gate lines G2, G4, . . . , Gx in sequence and the data driver 20 provides data signals DS of a second polarity in sequence to the scanned rows of pixels. For example, if the common voltage VCOM is kept at a negative voltage level, the second polarity is a positive voltage level with respect to the common voltage VCOM during the period PD2.

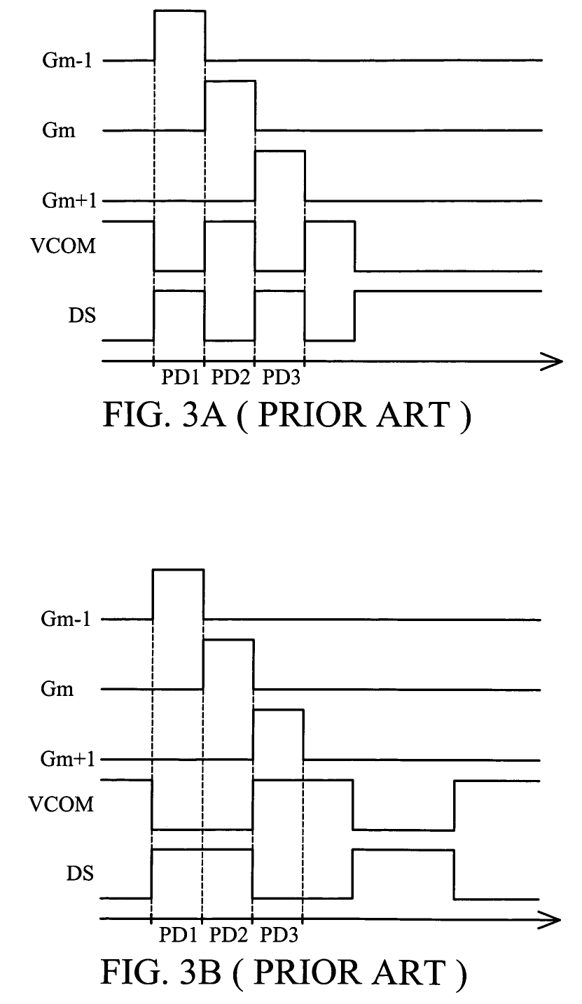

By scanning at least two scan lines and providing data signals with the same polarity in sequence to the scanned rows of pixels in one sub-period of a frame period, polarity switching times of data signals can be reduced. Thus, lower power consumption can be exhibited as compared to than conventional line inversion driving, such as shown in FIG. 3A.

Further, because the scanned rows of pixels in the sub-period are not adjacent to each other, flicker can be prevented when using a conventional N line inversion method such as shown in FIG. 3B.

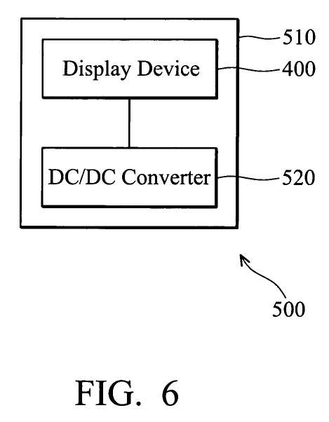

FIG. 6 schematically shows an embodiment of an electronic device 500 employing an embodiment of a display device. The display device can be a liquid crystal display system, an organic light-emitting diode (OLED) display system, or a field emission display (FED) system, although it is to be understood that the invention is not limited thereto. The electronic device 500 may be a portable device such as a PDA, notebook computer, tablet computer, cellular phone, or a display monitor device, etc. Generally, the electronic device 500 includes a housing 510, a display device such as the display device shown in FIG. 4, and a DC/DC converter 520., Further, the DC/DC converter 520 is operatively coupled to the display device and provides an output voltage powering the display device to display images.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving method for a display device comprising a plurality of pixels arranged in rows, the method comprising:
scanning N^{th} and (N+K)^{th} rows of pixels sequentially and providing a signal of a first polarity in sequence to the N^{th} and (N+K)^{th} rows of scanned pixels, during a first period of a frame period; and
scanning (N+1)^{th} and (N+K+1)^{th} rows of pixels sequentially and providing a signal of a second polarity in sequence to the scanned rows of pixels, during a second period of the frame period, wherein N and K are both integers, N>0, K is even and K>1.

2. The driving method as claimed in claim 1, wherein the first polarity is a negative voltage level with respect to a common voltage during the first period, and the second polarity is a positive voltage level with respect to the common voltage during the second period.

3. The driving method as claimed in claim 2, wherein the common voltage is kept at a positive voltage level during the first period and at a negative voltage level during the second period.

4. The driving method as claimed in claim 2, wherein a (N+2K)^{th} row of pixels is scanned after the (N+K)^{th} row of pixels during the first period, and a (N+2K+1)^{th} row of pixels is scanned after the (N+K+1)^{th} row of pixels during the second period.

5. A driving method for a display device comprising a plurality of pixels arranged in rows, the method comprising:
scanning odd-numbered rows of pixels sequentially and providing a signal of a first polarity in sequence to the odd-numbered rows of scanned pixels, during a first period of a frame period; and
scanning even-numbered rows of pixels sequentially and providing a signal of a second polarity in sequence to the even-numbered rows of scanned pixels, during a second period of the frame period.

6. The driving method as claimed in claim 5, wherein the first polarity is a negative voltage level with respect to a common voltage during the first period, and the second polarity is a positive voltage level with respect to the common voltage during the second period.

7. The driving method as claimed in claim 6, wherein the common voltage is kept at a positive voltage level during the first period and at a negative voltage level during the second period.

8. A device, comprising:
a display element comprising a plurality of pixels arranged in rows and columns;
a gate driver comprising a plurality of parallel gate lines, each gate line coupled to a corresponding row of pixels, and scanning a first row and a second row of pixels in sequence during a first period of a frame period, and scanning a third row and fourth row of pixels during a second period of the frame period, wherein the first and second rows of pixels are not adjacent and the third and fourth rows of pixels are not adjacent; and
a data driver comprising a plurality of parallel data lines, each orthogonal to the gate lines and coupled to a corresponding column of pixels, providing a signal of a first polarity in sequence to the scanned rows of pixels during the first period and a signal of a second polarity in sequence to the scanned rows of pixels during the second period.

9. The device as claimed in claim 8, wherein the gate driver scans N^{th} and (N+K)^{th} rows of pixels sequentially during the first period, and scans (N+1)^{th} and (N+K+1)^{th} rows of pixels sequentially during the second period, and N and K are both integers, N>0, K is even and K>1.

10. The device as claimed in claim 9, wherein the gate driver further scans a (N+2K)^{th} row of pixels after the (N+K)^{th} row of pixels during the first period, and further scans a (N+2K+1)^{th} row of pixels after the (N+K+1)^{th} row of pixels during the second period.

11. The device as claimed in claim 8, wherein the gate driver scans odd-numbered rows of pixels sequentially during the first period and scans even-numbered rows of pixels sequentially during the second period.

12. The device as claimed in claim 8, wherein the first polarity is a negative voltage level with respect to a common voltage during the first period, and the second polarity is a positive voltage level with respect to the common voltage during the second period.

13. The device as claimed in claim 12, wherein the common voltage is kept at a positive voltage level during the first period and at a negative voltage level during the second period.

14. The device as claimed in claim 8, wherein the display element is a liquid crystal display element.

15. The device as claimed in claim 8, further comprising a controller controlling scanning of the gate driver and signal providing of the data driver.

16. The device as claimed in claim 8, wherein the display element, gate driver and data driver are incorporated into a display device; and further comprising:
a DC/DC converter coupled to the display device, wherein the display device is powered by the DC/DC converter.

17. The device as claimed in claim 8, wherein the display element, gate driver and data driver are incorporated into a display device; and
further comprising means for powering the display device.

18. The electronic device as claimed in claim 15, wherein the electronic device is a PDA, a display monitor, a notebook computer, a tablet computer, or a cellular phone.

19. A device comprising:
means for scanning odd-numbered rows of pixels sequentially and providing a signal of a first polarity in sequence to the odd-numbered rows of scanned pixels, during a first period of a frame period; and
means for scanning even-numbered rows of pixels sequentially and providing a signal of a second polarity in sequence to the even-numbered rows of scanned pixels, during a second period of the frame period.

20. The device as claimed in claim 19, further comprising means for powering the means for scanning.
